(19) United States
(12) Patent Application Publication
(10) Pub. No.: US 2013/0130050 A1
(43) Pub. Date: May 23, 2013

(54) Multilayered Metal Including Titanium, and Method for Manufacturing Method Same

(71) Applicants: Nho Kwang Park, Gyeongsangnam-do (KR); Jae Keun Hong, Gyeongsangnam-do (KR); Jeoung Han Kim, Gyeongsangnam-do (KR); Chae Hun Lee, Busan (KR)

(72) Inventors: Nho Kwang Park, Gyeongsangnam-do (KR); Jae Keun Hong, Gyeongsangnam-do (KR); Jeoung Han Kim, Gyeongsangnam-do (KR); Chae Hun Lee, Busan (KR)

(73) Assignee: KOREA INSTITUTE OF MACHINERY & MATERIALS, Daejeon-si (KR)

(21) Appl. No.: 13/813,322

(22) PCT Filed: Dec. 20, 2010
(86) PCT No.: PCT/KR2010/009100

§ 371 Date: Jan. 30, 2013

(30) Foreign Application Priority Data
Jul. 30, 2010 (KR) 10-2010-0074407

(51) Int. Cl. B22F 7/02; B32B 15/01; C22C 1/04

(52) U.S. Cl. CPC B22F 7/02; C22C 1/0458; B32B 15/01
USPC 428/557; 419/69; 428/548

(57) ABSTRACT

A multilayer metal structure is provided that includes an inner layer of metal materials which are not titanium and outer layers on both sides of the inner layer which are formed by rolling titanium powders. A method for manufacturing the multilayer metal structure is provided that includes preparing titanium powders and metal materials which are not titanium, feeding the titanium powders and the metal materials to a vertical type rolling mill, simultaneously rolling the titanium powders and the metal materials by the rolling mill and forming the multilayer metal structure consisting of an inner layer and outer layers on both sides of the inner layer, and post-forming the multilayer metal structure to increase a packing density.

### BACKGROUND OF THE INVENTION

1. Field of the Invention

This invention relates to a multilayer metal structure having high corrosion resistance which is formed by simultaneously rolling titanium powders and other metal materials, and a method for manufacturing it.

2. Description of the Related Art

Many researches have been made in powder metallurgy due to the fact that metal powder materials make net shape manufacturing possible, which may not be applied for bulk materials, and show good characteristics resulting from uniform and fine microstructure. Very active materials, such as titanium, zirconium, niobium, molybdenum, tungsten, etc. among various powder metal materials must be plastically deformed in a high vacuum or inert atmosphere state in order to avoid oxidation, when they are subject to plastic deformation like forging, extrusion, rolling, elongation, etc. in a high temperature.

A general process to obtain titanium composite plates is that a refined titanium plate and a second single metal or alloyed plate are simultaneously under rolling deformation, such as hot rolling, cold rolling, etc. to become film-like composite plates or sheets. When materials including titanium are subject to hot rolling in a temperature above 500° C., the titanium is oxidized. Accordingly, the titanium plate and the second plate are laminated and hot-rolled in a vacuum state in order to avoid surface oxidation of the titanium plate. As the thickness of the plates or sheets becomes thinner, the plates or sheets need to be softened during hot rolling by a proper method, such as atmosphere annealing. While such a process guarantees a good quality product, the thinner the thickness of the plates or sheets, the higher their manufacturing costs. This is because the overall process becomes complex and consists of multiple steps.

The U.S. Pat. Nos. 4,617,054 and 4,602,954 disclose methods that titanium powders and a second metal materials, or titanium powders and alloy powders are mixed with a specific binder and subject to powder rolling to make a strip or sheet. Since the binder cannot be completely removed from the strip obtained after rolling, the strip cannot be compacted highly. Therefore, such methods have the problem that the mechanical properties of the strip are bad.

The U.S. Pat. No. 7,311,873 discloses a method for manufacturing strips from titanium-based powders using rolls of different diameters. The method provides a cold rolled strip having a density close to 100% of the theoretical value by direct powder rolling which adopts vertically-positioned rolls of diameters differing in a range of 1.1-5.0 mm, the strip being sintered afterward. However, since the method uses differential rolls, it is difficult to control the thickness of materials employed in the upper and lower parts of the strip and, therefore, to adjust the thickness of the upper and lower parts of the strip, when manufacturing a multilayer structure. In addition to such problems, the possibility that the upper and lower planes have different densities is high and, therefore, the possibility of defects in the strip is high.

Japanese publication no. 1994-155050 discloses a method for manufacturing titanium clad steel by hot rolling. This method has a disadvantage of surface oxidation.

### SUMMARY OF THE INVENTION

It is an object of this invention to provide a multilayer metal structure formed by simultaneously rolling titanium powders and another metal materials, and a method for manufacturing it.

Another object of the invention is to provide a multilayer metal structure including titanium, which has a high density by a post process, such as vacuum sintering, rolling, and the like, and a method for manufacturing it.

A further object of the invention is to provide a multilayer metal structure including titanium, which has a property selected in varying physical properties by mechanically adjoining titanium powders and another metal materials, and a method for manufacturing it.

According to the present invention, there is provided a multilayer metal structure comprising an inner layer of metal materials which are not titanium and outer layers on both sides of the inner layer which are formed by rolling titanium powders. Preferably, the outer layers have a packing density of 95 vol. % or more. The outer layers are formed of the titanium powders having a particle size of less than 100 mesh and the inner layer is formed of the metal materials in powder having a particle size of less than 100 mesh. The inner layer is in the form of plate, bar, or shape. According to the invention, the outer and inner layers are mechanically adjoined.

According to the present invention, there is provided a method for manufacturing a multilayer metal structure comprising the steps of: preparing titanium powders and metal materials which are not titanium, feeding the titanium powders and the metal materials to a vertical type rolling mill, simultaneously rolling the titanium powders and the metal materials by the rolling mill and forming the multilayer metal structure consisting of an inner layer and outer layers on both sides of the inner layer, and post-forming the multilayer metal structure to increase a packing density. Preferably, the titanium powders are an agglomerate type having a content of interstitial elements of 6000 ppm or less. In the preparing step, the fluidity of the metal materials is higher than that of the titanium powders. The titanium powders and the metal materials in powder maybe simultaneously fed in the feeding step. Or, the titanium powders and the metal materials in the form of plate, bar, or shape may be simultaneously fed in the feeding step. According to the invention, the outer layers have a packing density between 60 vol. % and 90 vol. % after the rolling step, and a packing density of 95 vol. % after the post-forming step. It is preferable that the multilayer metal structure after the post-forming step has a thickness between 0.1 mm and 3.0 mm.

As discussed, the present invention provides the multilayer metal structure including titanium, which has a high density by simultaneously rolling the titanium powders and the metal materials, and performing the post-forming step, such as vacuum sintering, rolling etc., and its manufacturing method. Therefore, the titanium powders and the metal materials are mechanically adjoined. According to the present invention, formability is improved and varying microstructural, chemicophysical, mechanical and structural properties may be embodied in the obtained product. Further, productivity is increased and manufacturing costs are decreased, because a very thin multilayer metal structure can be manufactured by a relatively simple process. Also, in addition to a multilayer structure having a plate form, the present invention may provide a multilayer bar structure having a variety of sectional shapes, which may be obtained by using rolls having a specific shape on their outer surface.

### BRIEF DESCRIPTION OF THE DRAWINGS

FIG. 1 is a sectional view schematically showing a vertical type rolling mill for embodying a first embodiment of a multilayer metal structure according to the present invention.

FIG. 2 is a sectional view schematically showing a vertical type rolling mill for embodying a second embodiment of a multilayer metal structure according to the present invention.

FIG. 3 is a sectional view schematically showing a vertical type rolling mill for embodying a third embodiment of a multilayer metal structure according to the present invention.

FIG. 4 is a process chart showing a method for manufacturing a multilayer metal structure according to the present invention.

FIG. 5 is a SEM photo showing a section of a multilayer metal structure obtained after a rolling step in the present method.

FIG. 6 is an X-ray mapping image showing a section of a multilayer metal structure obtained after a rolling step in the present method.

### DETAILED DESCRIPTION OF THE PREFERRED EMBODIMENTS

Referring to FIG. 1, a multilayer metal structure according to the present invention and a vertical type rolling mill manufacturing the multilayer metal structure will be described below. FIG. 1 is a sectional view schematically showing the vertical type rolling mill 100 for embodying a first embodiment of the multilayer metal structure 10 including titanium (hereafter, ‘the multilayer structure’).

As shown, the multilayer structure consists of multiple layers so that it may have varying properties. The multilayer structure comprises an inner layer 14 of metal materials 15 which are not titanium and outer layers 12 on both sides of the inner layer which are formed by rolling titanium powders 13. The metal materials used in the outer layer 12 and the inner layer 14 are different from each other. As said, the metal materials of the outer layers 12 are titanium and the metal materials of the inner layer 14 are a metal except titanium. The outer layers 12 are formed by rolling the titanium powders 13 using the vertical type rolling mill 100 and the inner layer 14 is simultaneously formed in the rolling mill 100 together with the outer layers 12. The inner layer may have various shapes and be formed of various materials. That is, the materials suitable for the inner layer 14 include alloyed metal powders not comprising titanium, and single metal powders, such as nickel, iron, aluminum, etc. The inner layer 14 may be fed to the rolling mill 100 in a plate form and, therefore, the outer layers 12 on both outer sides of the inner layer are flatly formed. Or, the inner layer 14 may be fed to the rolling mill 100 in a bar form and, therefore, the outer layer outside the inner layer is formed like a tube. Both of the outer and inner layers 12, 14 may be fed in a powder form and simultaneously rolled. In this case, the titanium powders 13 and the metal materials 15 in powder used in the outer and inner layers 12, 14 respectively must have fluidities different from each other, and it is preferable that the fluidity of the metal materials 15 in powder is higher than that of the titanium powders 13. As a result, if the titanium powders 13 and the metal materials 15 in powder are simultaneously fed and rolled, the inner and outer layers 14, 12 formed by rolling are mechanically adjoined to be the multilayer structure 10.

Referring to FIG. 1, the rolling mill 100 will be described below.

The rolling mill 100 comprises a couple of rolls 120 and a feeder 140. Each of the rolls 120 rotates in the opposite direction and the width between the rolls can be changed. The feeder 140 guides the titanium powders 13 and the metal materials 15 into the opened space between the rolls 120. The feeder 140 is placed at the upper side of the opened space between the rolls 120 and guides the titanium powders 13 and the metal materials 15 downwardly. For smooth guidance, the feeder 140 is slanted inwardly toward the vertical center line of the opened space. The ratio between the thickness of the inner layer 14 and the thickness of the outer layers 12 may be adjusted by controlling the outlet size of the feeder 140 and the height of the charged titanium powder 13. The feeder 140 may be provided with a vibrating device (not shown) which serves to help the powders flow smoothly. The metal materials 15 are centrally placed in the feeder 140 and guided downwardly, and the titanium powders 13 are continuously supplied into the feeder 140. Therefore, when the rolls 120 rotate, the outer layers 12 of the titanium powders 13 are formed on both sides of the metal materials 15. As such, the multilayer structure 10 is produced in an easy way.

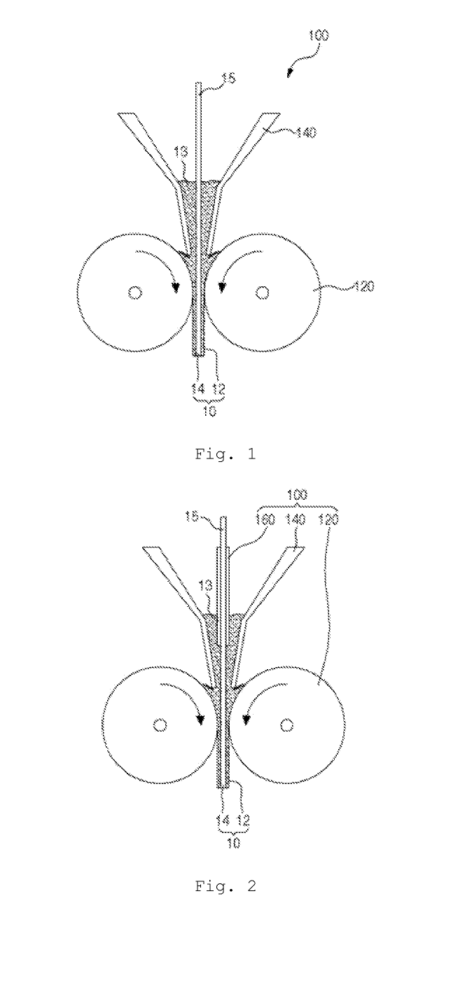

Referring to FIG. 2, another embodiment of the rolling mill 100 will be described below. FIG. 2 schematically shows the vertical type rolling mill 100 for embodying a second embodiment of the multilayer structure 10 according to the present invention.

As shown, the rolling mill 100 is further provided with a guide 160 for guiding the movement of the metal materials 15. The guide 160 serves to guide the metal materials in the form of plate or rod downwardly, straightly, and, also, prevent twisting and eccentricity of the metal materials, which are usually occurred during rolling. Therefore, the guide 160 may have a variety of internal shapes depending on the sectional shape of the metal materials 15. Of course, the length of the guide 160 may be increased or decreased. Also, the guide 160 may consist of a number of rolling mills which downwardly guide the metal materials 15 by rotation.

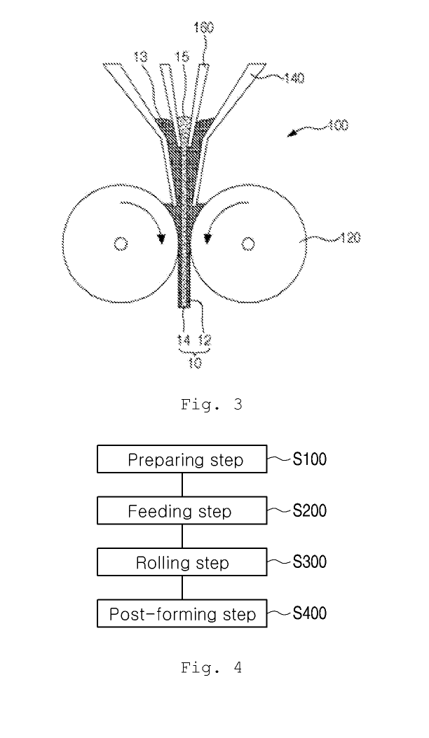

Referring to FIG. 3, another embodiment of the rolling mill 100 will be described below. FIG. 3 schematically shows the vertical type rolling mill 100 for embodying a third embodiment of a multilayer structure 10 according to the present invention.

As shown, the shape of the guide 160 in the rolling mill 100 is similar to that of the feeder 140. When the multilayer structure 10 is formed of the metal materials 15 in powder and the titanium powders 13, the guide 160 serves to part the metal materials 15 in powder from the titanium powder 13 and help the metal materials 15 in powder flow downwardly. To achieve such aims, the guide 160 is centrally placed within the feeder 140 and the width of the lower part of the guide 160 is narrower than that of the upper part of the guide 160. Resulting from such construction, after the metal materials 15 in powder exit from the guide 160, mixing between the metal materials 15 in powder and the titanium powders 13 downwardly moving in the feeder 140 is prevented. Even though not shown in the drawing, a plurality of guides 160, into which different metal materials are respectively supplied, may be provided in order to obtain the multilayer structure 10 consisting of various metal materials.

Referring to FIG. 4, a method for manufacturing the multilayer structure 10 using one of the rolling mills 100 will be described below. FIG. 4 is a process chart which shows the method for manufacturing the multilayer metal structure 10 according to the present invention.

As shown in the chart, the method for manufacturing the multilayer structure 10 comprises a preparing step S100 in which the titanium powders 13 and the metal materials 15 are prepared, a feeding step S200 in which the titanium powders 13 and the metal materials 15 are fed to the rolling mill 100, a rolling step S300 in which the supplied titanium powders 13 and metal materials 15 are simultaneously rolled by the rolling mill 100 and the multilayer structure 10 consisting of the inner layer 14 and the outer layers 12 is produced, a post-forming step S400 in which the multilayer structure 10 is post-formed to increase a packing density.

In the preparing step S100, the metal materials 15 in the form of plate, bar, shape, or powder, and the titanium powders 13 are prepared. One of the rolling mills 100 shown in FIG. 1 to FIG. 3 is chosen depending on the form of the metal materials 15. As titanium powders 13 in the preparing step S100, lump titanium powders, which are very pure and have a content of interstitial elements (oxygen or nitrogen) of 6000 ppm or less, are used. It is preferable that a particle size of the titanium powders 13 is less than 100 mesh, the smaller the particle size of the titanium powders, the better. The lump titanium powders maybe produced using a variety of processes, such as HDH process, vapor phase reduction process, liquid phase reduction process, etc. When the metal materials 15 in powder are used, it is preferable that a particle size of the metal material in powder is also less than 100 mesh. Preferably, the fluidity of the metal materials is higher than that of the titanium powders.

In the feeding step S200, the titanium powders 13 and the metal materials 15 prepared in the preparing step S100 are fed to the rolling mill 100. That is, the titanium powders 13 are charged into the feeder 140 and the metal materials 15 are centrally placed in the feeder 140.

In the rolling step S300, the titanium powders 13 and metal materials 15, which are simultaneously, downwardly supplied through the feeder 140 and the guide 160, are fed between a couple of rolls 120 and rolled. The titanium powders 13 and the metal materials 15 become the outer layers 12 and the inner layer 14 respectively after rolling. The outer and inner layers 12, 14 are mechanically adjoined by rolling and, finally, become the multilayer structure 10. A packing density of the multilayer structure 10 obtained in the rolling step S300 is low. More specifically, the outer layers 12 formed by the titanium powders 13 have a packing density between 60 vol.-% and 90 vol. %, and a ductile property.

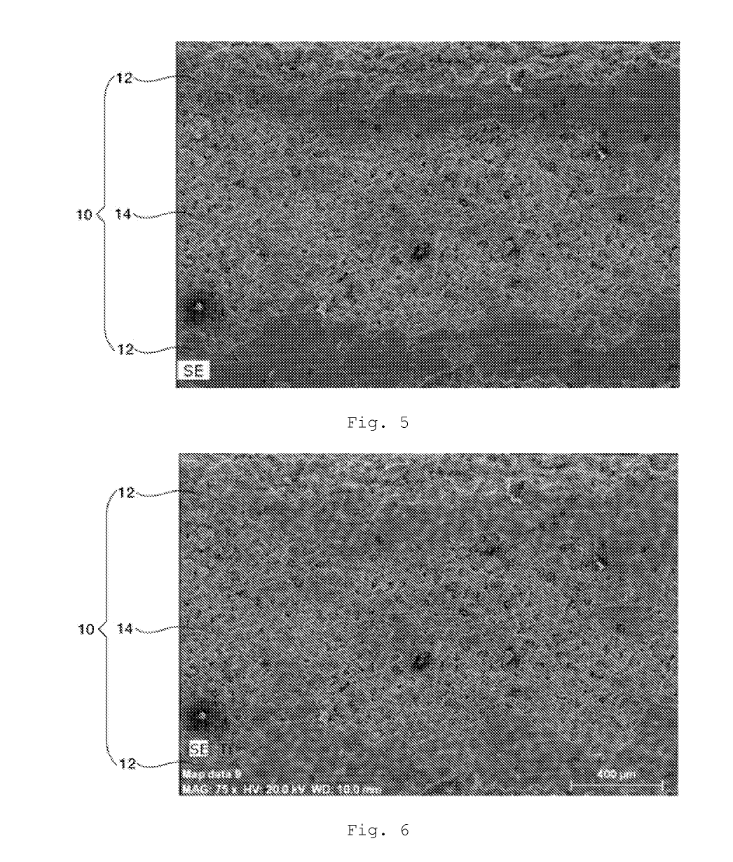

FIGS. 5 and 6 show a sectional view of the multilayer structure 10 obtained by simultaneously rolling the metal materials 15 in powder and the titanium powders 13. FIGS. 5 and 6 are respectively a SEM photo and an X-ray mapping image of the multilayer structure obtained after the rolling step of the present method. They show the multilayer structure 10 consisting of the inner layer 14 of nickel and the outer layers 12 of titanium.

After the rolling step S300, the multilayer structure 10 is subject to the post-forming step S400. The purpose of the post-forming step S400 is to increase the packing density of the outer layers 12. For this purpose, a variety of processes may be adopted. For example, cold rolling, coiling and sintering, or hot rolling may be used in the post-forming step S400. After the post-forming step S400, the outer layers in the multilayer structure 10 have a packing density of 95 vol. % or more.

A method for manufacturing the multilayer structure 10 and the specific conditions adopted in the method will be explained below.

### EXAMPLE 1

Lump titanium powders produced by the HDH process, which had a particle size of less than 200 mesh and purity of 99.5%, and nickel powders having a particle size of less than 200 mesh and purity of 99.8% were prepared (the preparing step:S100). The titanium and nickel powders were fed into the rolling mill 100 shown in FIG. 3 (the feeding step:S200) and simultaneously rolled by the rolls 120 (the rolling step:S300). The obtained three-layered Ti/Ni/Ti metal structure 10 had a packing density between 60 vol. % and 80 vol. % and a thickness between 1 mm and 1.5 mm. The obtained metal structure 10 was sintered in a vacuum atmosphere, at a temperature of 1200° C., and during 2 hours (the post-forming step: S400). The packing density of the three-layered Ti/Ni/Ti metal structure after the last step was above 95 vol. %.

The multilayer structure 10 manufactured by the above method showed high corrosion resistance owing to titanium on both sides of the multilayer structure and high thermal conductivity owing to nickel in the interior part of the multilayer structure. Also, the formability, such as drawability tc., of the multilayer structure was increased.

It is understood that while particular forms or embodiments of the present invention have been illustrated, various modifications can be made without departing from the spirit and scope of the invention.

1. A multilayer metal structure comprises an inner layer of metal materials which are not titanium and outer layers on both sides of the inner layer which are formed by rolling titanium powders.

2. The multilayer metal structure according to claim 1, wherein the outer layers have a packing density of 95 vol. % or more.

3. The multilayer metal structure according to claim 2, wherein the outer layers are formed of the titanium powders having a particle size of less than 100 mesh and the inner layer is formed of the metal materials in powder having a particle size of less than 100 mesh.

4. The multilayer metal structure according to claim 2, wherein the inner layer is in the form of plate, bar, or shape.

5. The multilayer metal structure according to claim 3, wherein the outer and inner layers are mechanically adjoined.

6. A method for manufacturing a multilayer metal structure comprises the steps of: preparing titanium powders and metal materials which are not titanium, feeding the titanium powders and the metal materials to a vertical type rolling mill, simultaneously rolling the titanium powders and the metal materials by the rolling mill and forming the multilayer metal structure consisting of an inner layer and outer layers on both sides of the inner layer, and post-forming the multilayer metal structure to increase a packing density.

7. The method according to claim 6, wherein the titanium powders are an agglomerate type having a content of interstitial elements of 6000 ppm or less.

8. The method according to claim 7, wherein, in the preparing step, the fluidity of the metal materials is higher than that of the titanium powders.

9. The method according to claim 8, wherein the titanium powders and the metal materials in powder are simultaneously fed in the feeding step.

10. The method according to claim 8, wherein the titanium powders and the metal materials in the form of plate, bar, or shape are simultaneously fed in the feeding step.

11. The method according to claim 9, wherein the outer layers formed in the rolling step have a packing density between 60 vol. % and 90 vol. %.

12. The method according to claim 11, wherein the outer layers after the post-forming step have a packing density of 95 vol. %.

13. The method according to claim 12, wherein the multilayer metal structure after the post-forming step has a thickness between 0.1 mm and 3.0 mm.

14. The multilayer metal structure according to claim 4, wherein the outer and inner layers are mechanically adjoined.

15. The method according to claim 10, wherein the outer layers formed in the rolling step have a packing density between 60 vol. % and 90 vol. %.
